(19) United States
(12) Patent Application Publication
(10) Pub. No.: US 2024/0351554 A1
(43) Pub. Date: Oct. 24, 2024

(54) BUCKLE DEVICE

(71) Applicant: KABUSHIKI KAISHA TOKAI-RIKA-DENKI-SEISAKUSHO, Aichi-ken (JP)

(72) Inventor: Ryuji YAMAGUCHI, Aichi (JP)

(73) Assignee: KABUSHIKI KAISHA TOKAI-RIKA-DENKI-SEISAKUSHO, Aichi-ken (JP)

(21) Appl. No.: 18/624,787

(22) Filed: Apr. 2, 2024

(30) Foreign Application Priority Data
Apr. 20, 2023 (JP) 2023-069588

(51) Int. Cl. B60R 22/18; B60R 22/34

(52) U.S. Cl. CPC B60R 22/18; B60R 22/34; B60R 2022/1806; B60R 2022/3427

(57) ABSTRACT

In a buckle device, a sewn part of a belt is wound around a spool. Here, the sewn part is disposed in an upper peripheral region and a left peripheral region of the spool. Therefore, even though a winding radius of the belt is increased by the sewn part, it is possible to suppress an occurrence of a situation in which a left covering part and a right covering part of a boot are displaced outward in a vehicle width direction of the boot by the belt, and it is possible to reduce a size of the buckle device in the vehicle width direction.

### CROSS-REFERENCE TO RELATED APPLICATION

This application is based on and claims priority under 35 USC 119 from Japanese Patent Application No. 2023-69588 filed on Apr. 20, 2023, the disclosure of which is incorporated by reference herein.

### BACKGROUND

### Technical Field

The present invention relates to a buckle device in which one end side of a belt is coupled to a buckle body and another end side of the belt is coupled to a winding member.

### Related Art

In the buckle device disclosed in Japanese Patent Application Laid-Open (JP-A) No. 2020-125010, one end side of a webbing is coupled to a buckle body, another end side of the webbing is coupled to a spool, and the webbing is wound around the spool. Further, one side of the spool in a vehicle width direction is covered with a cover, and the webbing wound around the spool faces the cover in the vehicle width direction.

Here, in such a buckle device, it is preferable that the size in the vehicle width direction can be reduced.

### SUMMARY

In view of such circumstances, an object of the invention is to obtain a buckle device capable of reducing a size in a vehicle width direction.

According to a first aspect of the invention, a buckle device includes a buckle body configured to engage with a tongue provided at a webbing attached to an occupant; a belt that has one end side coupled to the buckle body and that is provided with a sewn part; a winding member to which another end side of the belt is coupled and around which the sewn part is wound; a one-side covering part that covers one side of the winding member in a vehicle width direction; and an other-side covering part that covers another side of the winding member in the vehicle width direction, wherein, in a case in which a circumferential region of the winding member is equally divided into an upper peripheral region above the winding member, a lower peripheral region below the winding member, one peripheral region at one direction of the winding member in the vehicle width direction, and another peripheral region at another direction of the winding member in the vehicle width direction, the sewn part is disposed in a plurality of peripheral regions including only one of the one peripheral region or the other peripheral region.

In the buckle device in the first aspect of the invention, the buckle body is configured to engage with a tongue provided at the webbing attached to the occupant. In addition, the one end side of the belt is coupled to the buckle body, the other end side of the belt is coupled to the winding member, and the sewn part of the belt is wound around the winding member. Further, the one-side covering part covers the one side of the winding member in the vehicle width direction, and the other-side covering part covers the other side of the winding member in the vehicle width direction.

Here, in a case in which the circumferential region of the winding member is equally divided into the upper peripheral region above the winding member, the lower peripheral region below the winding member, the one peripheral region at the one direction of the winding member in the vehicle width direction, and the other peripheral region at the other direction of the winding member in the vehicle width direction, the sewn part is disposed in the plurality of peripheral regions including only one of the one peripheral region or the other peripheral region. Therefore, in a case in which the sewn part is disposed in the plurality of peripheral regions, even though the winding radius of the belt (the radius of the outer periphery of a winding part of the belt around the winding member) is increased by the sewn part, it is possible to suppress an occurrence of a situation in which the one-side covering part and the other-side covering part are displaced in the vehicle width direction by the belt, and it is possible to reduce the size of the buckle device in the vehicle width direction.

In a buckle device according to a second aspect of the invention, in the buckle device according to the first aspect of the invention, the belt is not brought into contact with at least one of the one-side covering part or the other-side covering part.

In the buckle device according to the second aspect of the invention, the belt is not brought into contact with at least one of the one-side covering part or the other-side covering part. Therefore, it is possible to effectively suppress an occurrence of a situation in which at least one of the one-side covering part or the other-side covering part is displaced in the vehicle width direction by the belt.

In a buckle device according to a third aspect of the invention, in the buckle device according to the second aspect of the invention, the belt is not brought into contact with the one-side covering part and the other-side covering part.

In the buckle device according to the third aspect of the invention, the belt is not brought into contact with the one-side covering part and the other-side covering part. Therefore, it is possible to effectively suppress an occurrence of a situation in which the one-side covering part and the other-side covering part are displaced in the vehicle width direction by the belt.

A buckle device according to a fourth aspect of the invention, in the buckle device according to any one of the first to third aspects of the invention, further includes a deformation member that is deformed in a case in which allowing the belt to be pulled out from the winding member is started, and by which the belt on an outer side of the sewn part in a radial direction of the winding member is allowed to be pulled out from the winding member.

In the buckle device according to the fourth aspect of the invention, in a case in which allowing the belt to be pulled out from the winding member is started, the deformation member is deformed, and by which the belt on the outer side of the sewn part in the radial direction of the winding member is allowed to be pulled out from the winding member. Therefore, the winding radius of the belt is increased by the sewn part, and the torque applied to the winding member by the belt is increased, so that it is possible to increase the load for deforming the deformation member.

### BRIEF DESCRIPTION OF THE DRAWINGS

Exemplary embodiments of the present invention will be described in detail based on the following figures, wherein:

FIG. 1 is an exploded perspective view illustrating a buckle device according to an embodiment of the invention as viewed from diagonally front right;

FIG. 2 is a cross-sectional view illustrating the buckle device according to the embodiment of the invention as viewed from right;

FIG. 3 is a front view illustrating the inside of the buckle device according to the embodiment of the invention as viewed from front;

FIG. 4 is a front view illustrating a spool and a belt of the buckle device according to the embodiment of the invention as viewed from the front; and

FIG. 5 is a right side view illustrating a buckle and the belt of the buckle device according to the embodiment of the invention as viewed from the right.

### DETAILED DESCRIPTION

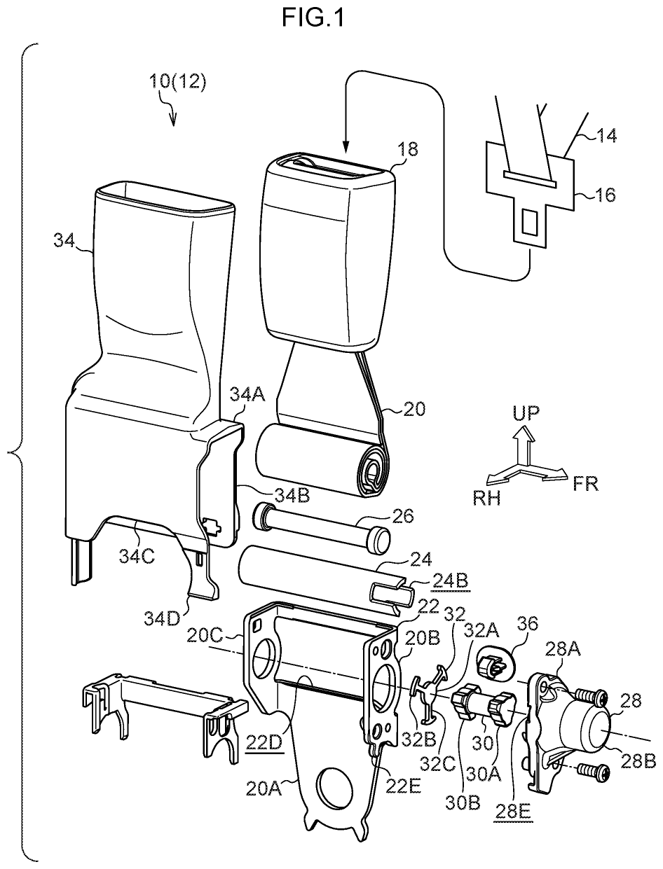

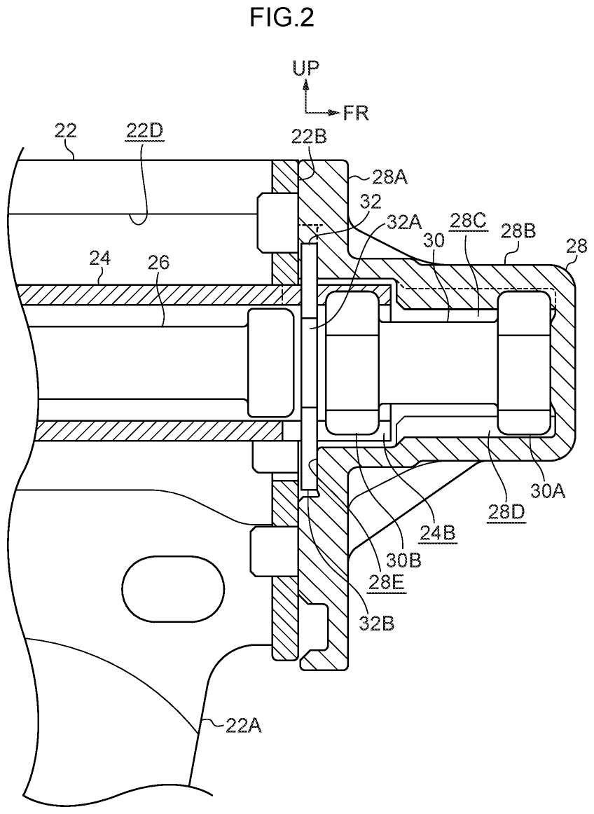

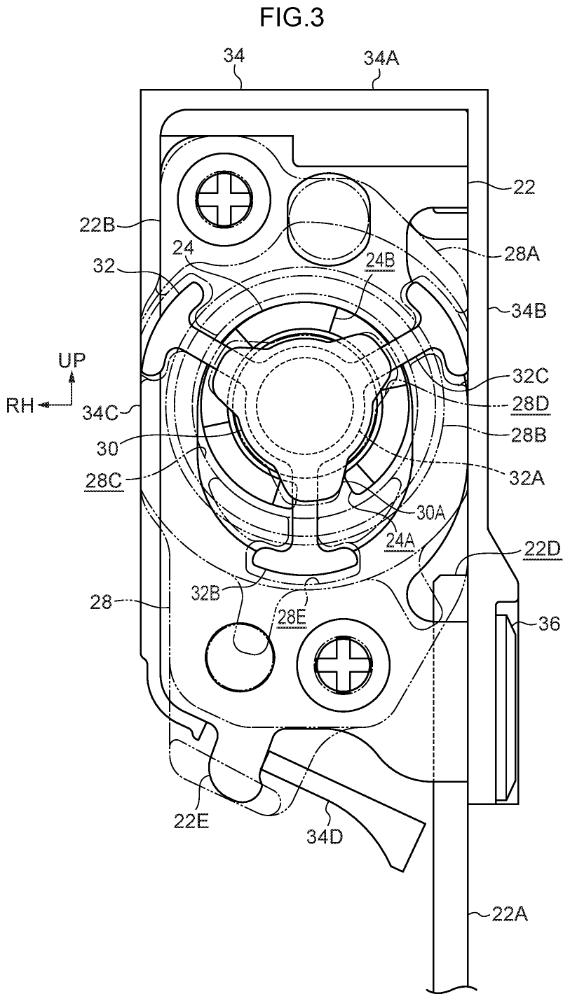

FIG. 1 is an exploded perspective view illustrating a buckle device 10 according to an embodiment of the invention as viewed from the diagonally front right. FIG. 2 is a cross-sectional view illustrating the buckle device 10 as viewed from the right. Furthermore, FIG. 3 is a front view illustrating the inside of the buckle device 10 as viewed from the front. In the drawings, the front of the buckle device 10 is indicated by an arrow FR, the right (obverse side) of the buckle device 10 is indicated by an arrow RH, and the upper side of the buckle device 10 is indicated by an arrow UP.

The buckle device 10 according to the present embodiment constitutes a seat belt device 12 of a vehicle (automobile). The seat belt device 12 is applied to a seat (not illustrated) in a vehicle interior. The seat belt device 12 is provided with a winding device (not illustrated). The winding device is installed on the outer side in a vehicle width direction and the lower side of a seat rear part. In the winding device, a webbing 14 (see FIG. 1) having a long band shape is wound from the proximal end side. A webbing 14 is biased to the winding side to the winding device and pulled out to the upper side of the winding device. The winding device is provided with a lock mechanism, and the lock mechanism locks pulling-out of the webbing 14 from the winding device in an emergency of the vehicle (in collision or the like).

The webbing 14 passes through a through anchor (not illustrated) movably on the distal end side with respect to the winding device. The through anchor is installed on the outer side in the vehicle width direction and the upper side of the seat rear part. An anchor (not illustrated) is fixed to the distal end part of the webbing 14, and the anchor is installed on the outer side in the vehicle width direction and the lower side of the seat rear part. The webbing 14 movably passes through a tongue 16 (see FIG. 1) between the through anchor and the anchor.

The buckle device 10 is installed on the inner side in the vehicle width direction and the lower side of the seat rear part. The front, the right, and the upper side of the buckle device 10 are directed toward the front side or the rear side, and directed inward in the vehicle width direction, and directed upward, respectively.

As illustrated in FIG. 1, a buckle body 18 having a substantially rectangular parallelepiped shape is provided at the upper part of the buckle device 10, and a size of a lower part of the buckle body 18 is gradually reduced toward the lower side in the right-left direction. The tongue 16 is engageable with the buckle body 18 from the upper side. The tongue 16 is engaged with the buckle body 18, and the webbing 14 is attached to an occupant seated on a seat. As a result, a part (shoulder webbing) of the webbing 14 between the through anchor and the tongue 16 is stretched obliquely from the shoulder part to the waist part (including the chest part) of the occupant, and a part (wrap webbing) of the webbing 14 between the tongue 16 and the anchor is stretched laterally to the waist part of the occupant. The engagement of the tongue 16 with the buckle body 18 is releasable. The engagement of the tongue 16 with the buckle body 18 is released to release the attachment of the webbing 14 to the occupant.

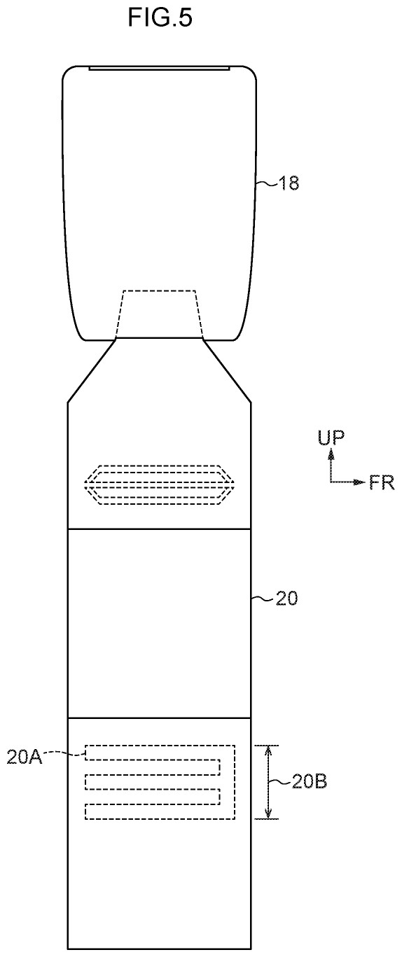

A distal-end side part (upper side part) of a band-shaped belt 20 (webbing, see FIG. 5) as a coupling member is coupled to the lower part of the buckle body 18. The belt 20 is formed of a woven fabric and made of, for example, the same material as the material of the webbing 14. The proximal end part (lower end part) of the belt 20 is overlapped with the vicinity of the proximal end part of the belt 20, and the proximal end of the belt 20 is sewn to the vicinity of the proximal end part of the belt 20 with a sewn thread 20A, whereby the proximal end side part (lower side part) of the belt 20 is made annular. A longitudinal range in which the sewn thread 20A is disposed in the proximal end side part of the belt 20 is a sewn part 20B. The sewn part 20B has lower flexibility (hardness) and a larger thickness than a part of the proximal end side part (overlapping part) of the belt 20 other than the sewn part 20B.

As illustrated in FIGS. 1 to 3, a frame 22 made of metal as a support is provided in a lower part of the buckle device 10, and the frame 22 is made to have a U-shaped plate shape in a cross section. A back plate 22A is provided at a left part of the frame 22. The frame 22 is fixed to a vehicle body side (for example, a rear part of a seat lower part) at a lower end part of the back plate 22A. Leg plates 22B and 22C are provided at the front part and the rear part of the frame 22, respectively. The leg plates 22B and 22C protrude rightward from the back plate 22A. A through-hole 22D having a rectangular shape is formed at the upper part of the back plate 22A to penetrate. The through-hole 22D is disposed in the entirety of the back plate 22A in the right-left direction. A fixing piece 22E having a substantially rectangular plate shape is integrally formed on the lower side of the leg plate 22B, and the fixing piece 22E protrudes downward.

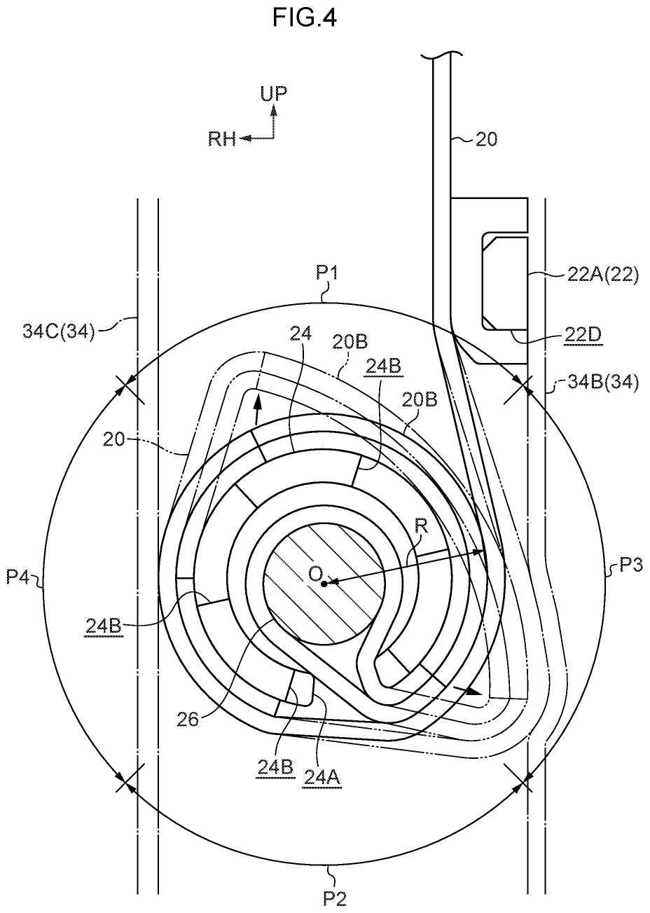

A spool 24 (see FIG. 4) that is made of metal and has a substantially tubular shape as a winding member is supported by the frame 22. The spool 24 penetrates the leg plate 22B and the leg plate 22C of the frame 22. The axial direction of the spool 24 is set to be the front-rear direction, and the spool 24 is rotatable about the central axis. The through-hole 22D of the frame 22 (back plate 22A) is disposed on the left side of the spool 24, and the spool 24 is exposed on the left side of the frame 22. An insertion hole 24A having a long rectangular shape is formed in the spool 24 to penetrate. The insertion hole 24A is extended in the axial direction of the spool 24 and is opened to the front side and the rear side. A plurality (three in the embodiment) of coupling hole 24B having a rectangular shape as coupling target parts are formed at the front part of the spool 24 to penetrate. The plurality of coupling hole 24B are arranged at equal intervals in the circumferential direction of the spool 24. The coupling hole 24B is opened to the front side, and one coupling hole 24B communicates with the insertion hole 24A.

It is assumed that the circumferential region of the spool 24 is equally divided into an upper peripheral region P1 above the spool 24, a lower peripheral region P2 below the spool 24, a left peripheral region P3 (one peripheral region) on the left (outside in the vehicle width direction) of the spool 24, and a right peripheral region P4 (another peripheral region) on the right (inside in the vehicle width direction) of the spool 24. The circumferential centers of the upper peripheral region P1, the lower peripheral region P2, the left peripheral region P3, and the right peripheral region P4 in the spool 24 are disposed above, below, to the left, and to the right of a central axis O of the spool 24, respectively.

A bar 26 that is made of metal and has a substantially columnar shape as a locking member is coaxially inserted into the spool 24, and both end parts of the bar 26 in the axial direction are coaxially enlarged in diameter and fitted into the spool 24. The proximal end side part (annular part) of the belt 20 is inserted into the insertion hole 24A of the spool 24, and the intermediate part of the bar 26 in the axial direction is inserted therein, whereby the proximal end side part of the belt 20 is locked in the spool 24 by the bar 26 and coupled to the spool 24. The belt 20 is wound around the spool 24, and the belt 20 is pulled out from the left side to the upper side of the spool 24. The insertion hole 24A of the spool 24 is disposed at the substantially lower end part of the spool 24. The proximal end side part of the belt 20 is wound from the insertion hole 24A to the left side, the upper side, and the right side of the spool 24 in this order, and the distal end side from the proximal end side part of the belt 20 is wound from the lower side to the left side of the spool 24 and pulled out.

The sewn part 20B of the proximal end side part of the belt 20 is disposed in the upper peripheral region P1 and the left peripheral region P3 of the spool 24. The pull-out position of the belt 20 from the spool 24 is disposed on the outer side of the sewn part 20B in the radial direction of the spool 24. The sewn part 20B is wound around the spool 24 in a state where the flexibility is set to be low and the curvature is made smaller than the curvature of the outer peripheral surface of the spool 24. The both end sides of the sewn part 20B in the longitudinal direction of the belt 20 are separated outward from the outer peripheral surface of the spool 24 in the radial direction (see a two-dot chain line in FIG. 4). The thickness of the sewn part 20B is made larger than the thickness of a part of the proximal end side part of the belt 20 other than the sewn part 20B, and the winding radius of the sewn part 20B of the belt 20 (the radius of the outer periphery of the winding part of the belt 20 around the spool 24) is made larger than the winding radius of a part of the proximal end side part of the belt 20 other than the sewn part 20B.

A case 28 that is made of metal as a locking body is disposed on the front side of the frame 22 (leg plate 22B). The case 28 is provided with a fixing plate 28A that has a substantially rectangular plate shape as a fixing part. The fixing plate 28A is fixed to the leg plate 22B, and thus the case 28 is fixed to the leg plate 22B. A locking cylinder 28B having a substantially bottomed tubular shape is integrally formed on the front side of the fixing plate 28A. The axial direction of the locking cylinder 28B is set to the front-rear direction. The inside of the locking cylinder 28B is formed into an inner hole 28C having a substantially columnar shape, penetrates the fixing plate 28A, and is opened to the rear side of the fixing plate 28A. The front part of the spool 24 is coaxially inserted into the rear side part of the inner hole 28C. A plurality (three in the embodiment) of locking holes 28D having a substantially trapezoidal columnar shape as locking parts are formed at the front side part of the peripheral surface of the inner hole 28C. The plurality of locking holes 28D are arranged at equal intervals in the circumferential direction of the inner hole 28C. The locking hole 28D is extended in the front-rear direction (axial direction of the inner hole 28C), and the locking hole 28D is opened to the rear side part of the inner hole 28C. A plurality (three in the embodiment) of regulation recesses 28E having a substantially T-shape in a front view as regulation parts are formed on an outer side of the inner hole 28C in the radial direction on the rear surface of the fixing plate 28A. The plurality of regulation recesses 28E are arranged at equal intervals in the circumferential direction of the locking cylinder 28B. The distal end side part of the regulation recess 28E is extended in the circumferential direction of the inner hole 28C, and the proximal end side part of the regulation recess 28E is extended in the radial direction of the inner hole 28C and communicates with the inner hole 28C.

A torsion shaft 30 that is made of metal and has a substantially columnar shape as a restriction member (energy absorption member) is coaxially disposed at the inner hole 28C of the case 28. A plurality (three in the embodiment) of locking protrusions 30A each having a substantially trapezoidal columnar shape as a locking target part is integrally formed at the front end part of the torsion shaft 30. The plurality of locking protrusions 30A have an axial direction in the front-rear direction (axial direction of the torsion shaft 30) and are arranged at equal intervals in the circumferential direction of the torsion shaft 30. The locking protrusion 30A is inserted into the locking hole 28D of the case 28 (inner hole 28C), and the side surface thereof is brought into contact with the side surface of the locking hole 28D. Thus, the torsion shaft 30 is locked not to rotate relative to the case 28 (inner hole 28C). A plurality (three in the embodiment) of coupling protrusions 30B each having a substantially trapezoidal columnar shape as a coupling part is integrally formed at the rear end part of the torsion shaft 30. The plurality of coupling protrusions 30B have an axial direction in the front-rear direction (axial direction of the torsion shaft 30) and are arranged at equal intervals in the circumferential direction of the torsion shaft 30. The coupling protrusion 30B is inserted into the coupling hole 24B of the spool 24, and the side surface thereof is brought into contact with the side surface of the coupling hole 24B. Thus, the torsion shaft 30 is coupled to the spool 24 to restrict the rotation of the spool 24.

A shear plate 32 made of metal as a deformation member is disposed between the spool 24 and the torsion shaft 30. A base part 32A having a disc shape is coaxially provided at the central part of the shear plate 32. The base part 32A is coaxially inserted into the spool 24 on the rear side of the torsion shaft 30. A plurality (three in the embodiment) of breaking parts 32B having a substantially T-shape are integrally formed at the outer periphery of the base part 32A. The plurality of breaking parts 32B are arranged at equal intervals in the circumferential direction of the base part 32A. A distal end side part of the breaking part 32B is extended in the circumferential direction of the base part 32A. A proximal end side part of the breaking part 32B is formed into a breaking plate 32C having a long rectangular plate shape, is extended in the radial direction of the base part 32A, and is integrated with the base part 32A. In the breaking part 32B, the breaking plate 32C penetrates through the coupling hole 24B of the spool 24 and the proximal end side part of the regulation recess 28E of the case 28 (fixing plate 28A), and the distal end side part thereof is inserted into the distal end side part of the regulation recess 28E, the breaking plate 32C is brought into contact with the side surface of the proximal end side part of the regulation recess 28E, and thus the rotation of the shear plate 32 is regulated.

A boot 34 (cover) having a substantially rectangular cylindrical shape as a covering member is provided in a range from the buckle body 18 to the frame 22. The boot 34 is made of soft resin and has flexibility. The upper part of the boot 34 gradually becomes smaller downward in the right-left direction. The lower side part of the buckle body 18 is fitted into the upper part of the boot 34, thereby restricting the downward movement of the buckle body 18. The belt 20 is inserted into the intermediate part of the boot 34 in the up-down direction. The inside of the lower part of the boot 34 is opened to the front side, and the frame 22 (including the spool 24 and the bar 26) is fitted therein. A support frame 34A having a rectangular frame plate shape is integrally formed just above the lower part of the boot 34, and the belt 20 is inserted into the support frame 34A. The lower side of the support frame 34A is supported by the upper end of the frame 22, which restricts the downward movement of the boot 34. An elastic contraction force is applied to the boot 34 between the buckle body 18 and the frame 22 in a state where the belt 20 is wound around the spool 24 as described above, and thus the tension is applied to the belt 20. The boot 34 biases the frame 22 downward to be self-standing with respect to the frame 22 and biases the buckle body 18 upward to be self-standing. Even though the tension is applied to the belt 20 as described above, the sewn part 20B of the proximal end side part of the belt 20 is wound around the spool 24 in a state where the curvature thereof is smaller than the curvature of the outer peripheral surface of the spool 24 (see the two-dot chain line in FIG. 4).

The left wall of the lower part of the boot 34 is a left covering part 34B as a one-side covering part. The left covering part 34B covers the left side of the spool 24 (including the belt 20 wound around the spool 24) via the through-hole 22D of the frame 22 (back plate 22A). A clip 36 made of resin penetrates a lower end part of the left covering part 34B and the back plate 22A. The clip 36 sandwiches the left covering part 34B and the back plate 22A to fix the left covering part 34B to the frame 22. As described above, the curvature of the sewn part 20B of the proximal end side part of the belt 20 is made smaller than the curvature of the outer peripheral surface of the spool 24, whereby the belt 20 wound around the spool 24 is brought into contact with the left covering part 34B with a large load, and the left covering part 34B is displaced (elastically deformed) to the left side (see the one-dot chain line in FIG. 4).

The right wall of the lower part of the boot 34 is made into a right covering part 34C as the other-side covering part. The right covering part 34C covers the right side of the spool 24 (including the belt 20 wound around the spool 24). An extension piece 34D having a long rectangular plate shape is integrally formed at a front end part of the right covering part 34C. The extension piece 34D is extended downward. The extension piece 34D is hooked on the fixing piece 22E of the frame 22 (leg plate 22B) penetrating therethrough, whereby the right covering part 34C is fixed to the frame 22. In addition, even though the curvature of the sewn part 20B of the proximal end side part of the belt 20 is made smaller than the curvature of the outer peripheral surface of the spool 24 as described above, the belt 20 wound along the outer peripheral surface of the spool 24 is brought into contact with the right covering part 34C with a small load (particularly, circumscribed by the right covering part 34C), and thus the right covering part 34C is not substantially displaced (elastically deformed) to the right side (see the one-dot chain line in FIG. 4).

Next, the action of the embodiment will be described.

In the seat belt device 12 having the above configuration, in the buckle device 10, the torsion shaft 30 restricts the rotation of the spool 24 to restrict the pulling-out of the belt 20 from the spool 24 and the upward extension of the buckle body 18, and the webbing 14 is attached to the occupant by engaging the tongue 16 of the webbing 14 with the buckle body 18.

In an emergency of a vehicle (at the time of collision or the like), the locking mechanism in the winding device locks the pulling-out of the webbing 14, whereby the occupant is restrained by the webbing 14. For example, in a case in which an inertial force is applied to the occupant and the webbing 14 is pulled by the occupant, a pulling force from the spool 24 is applied to the belt 20 from the webbing 14 via the tongue 16 and the buckle body 18, whereby a rotational force is applied to the spool 24. Furthermore, in a case in which the torsion shaft 30 is deformed to be twisted by the rotational force applied to the spool 24, the rotation of the spool 24 is allowed, and the belt 20 is allowed to be pulled out from the spool 24, so that the buckle body 18 (including the tongue 16) is allowed to extend upward. Therefore, pulling-out of the webbing 14 by the occupant is allowed, and a load applied from the webbing 14 to the occupant (particularly, the chest part) is reduced (restricted to an extension allowable load (force limiter load) of the buckle body 18), and the kinetic energy of the occupant is absorbed by the torsional deformation of the torsion shaft 30.

Further, in a case in which allowing the rotation of the spool 24 is started, the side surface of the coupling hole 24B of the spool 24 is brought into contact with the breaking plate 32C of the shear plate 32, so that the breaking plate 32C can restrict the rotation of the spool 24 and restrict the pulling-out of the belt 20. Therefore, in a case in which the rotational force applied to the spool 24 is small (for example, at the time of light collision of the vehicle), the breaking plate 32C restricts the rotation of the spool 24, so that an occurrence of a situation in which the torsion shaft 30 is deformed to be twisted is suppressed. In a case in which the rotational force applied to the spool 24 is large, the breaking plate 32C is broken (deformed) by the side surface of the coupling hole 24B, so that the breaking plate 32C permits the rotation of the spool 24 and permits the pulling-out of the belt 20.

The sewn part 20B of the proximal end side part of the belt 20 is wound around the spool 24 in a state where the curvature is made smaller than the curvature of the outer peripheral surface of the spool 24. The both end sides of the sewn part 20B in the longitudinal direction of the belt 20 are separated outward from the outer peripheral surface of the spool 24 in the radial direction (see a two-dot chain line in FIG. 4).

Here, the sewn part 20B is disposed in the upper peripheral region P1 and the left peripheral region P3 of the spool 24. Therefore, in a case in which the sewn part 20B is disposed in a plurality of peripheral regions of the spool 24, even though the winding radius of the belt 20 is increased by the sewn part 20B, the left covering part 34B of the boot 34 is displaced to the left side by the winding part of the belt 20 around the spool 24, but the right covering part 34C of the boot 34 is not substantially displaced to the right side. As a result, it is possible to suppress the occurrence of a situation in which the left covering part 34B and the right covering part 34C are displaced outward in the right-left direction (vehicle width direction) of the boot 34, and it is possible to reduce the size of the buckle device 10 in the right-left direction.

In addition, in a case in which the torsion shaft 30 is deformed to be twisted and the rotation of the spool 24 is allowed in an emergency of the vehicle, the curvature of the sewn part 20B is increased by the pulling force applied to the belt 20, and the sewn part 20B is bent along the outer peripheral surface of the spool 24 (see the solid line in FIG. 4). The thickness of the sewn part 20B is made larger than the thickness of the part of the proximal end side part of the belt 20 other than the sewn part 20B, the pull-out position of the belt 20 from the spool 24 is disposed on the outer side of the sewn part 20B in the radial direction of the spool 24, and by which the winding radius R (see FIG. 4) at the pull-out position of the belt 20 from the spool 24 is large. Therefore, the torque applied to the spool 24 is increased by the belt 20, so that it is possible to increase the load for breaking the breaking plate 32C of the shear plate 32. As a result, it is possible to increase the width dimension (dimension in the circumferential direction of the spool 24) of the breaking plate 32C, and, even in a case in which the shear plate 32 is produced by press working, it is possible to easily produce the breaking plate 32C and to easily produce the shear plate 32.

In the embodiment, the winding part of the belt 20 around the spool 24 is brought into contact with the left covering part 34B and the right covering part 34C of the boot 34. However, the winding part of the belt 20 around the spool 24 does not need to be brought into contact with at least one of the left covering part 34B or the right covering part 34C of the boot 34 (particularly, the left covering part 34B and the right covering part 34C). As a result, it is possible to effectively suppress the occurrence of a situation in which the left covering part 34B and the right covering part 34C are displaced outward in the right-left direction of the boot 34 by the winding part of the belt 20 around the spool 24, and it is possible to effectively reduce the size of the buckle device 10 in the right-left direction.

In the embodiment, the sewn part 20B of the proximal end side part of the belt 20 is disposed in the upper peripheral region P1 and the left peripheral region P3 of the spool 24.

However, the sewn part 20B may be disposed in the upper peripheral region P1 and the right peripheral region P4 of the spool 24, the sewn part 20B may be disposed in the lower peripheral region P2 and the left peripheral region P3 of the spool 24, or the sewn part 20B may be disposed in the lower peripheral region P2 and the right peripheral region P4 of the spool 24. In this case, it is possible to suppress the occurrence of a situation in which the left covering part 34B and the right covering part 34C of the boot 34 are displaced outward in the right-left direction of the boot 34 by the winding part of the belt 20 around the spool 24.

Furthermore, the sewn part 20B may be disposed in the upper peripheral region P1, the right peripheral region P4, and the lower peripheral region P2 of the spool 24, or the sewn part 20B may be disposed in the upper peripheral region P1, the left peripheral region P3, and the lower peripheral region P2 of the spool 24. In this case, it is possible to suppress the occurrence of a situation in which the left covering part 34B and the right covering part 34C of the boot 34 are displaced outward in the right-left direction of the boot 34 by the winding part of the belt 20 around the spool 24.

What is claimed is:

1. A buckle device comprising:
a buckle body configured to engage with a tongue provided at a webbing attached to an occupant;
a belt that has one end side coupled to the buckle body and that is provided with a sewn part;
a winding member to which another end side of the belt is coupled and around which the sewn part is wound;
a one-side covering part that covers one side of the winding member in a vehicle width direction; and
an other-side covering part that covers another side of the winding member in the vehicle width direction,
wherein, in a case in which a circumferential region of the winding member is equally divided into an upper peripheral region above the winding member, a lower peripheral region below the winding member, one peripheral region at one direction of the winding member in the vehicle width direction, and another peripheral region at another direction of the winding member in the vehicle width direction, the sewn part is disposed in a plurality of peripheral regions including only one of the one peripheral region or the other peripheral region.

2. The buckle device according to claim 1, wherein the belt is not brought into contact with at least one of the one-side covering part or the other-side covering part.

3. The buckle device according to claim 2, wherein the belt is not brought into contact with the one-side covering part and the other-side covering part.

4. The buckle device according to claim 1, further comprising: a deformation member that is deformed in a case in which allowing the belt to be pulled out from the winding member is started, and by which the belt on an outer side of the sewn part in a radial direction of the winding member is allowed to be pulled out from the winding member.

5. The buckle device according to claim 1, wherein flexibility of the sewn part is lower than flexibility of a part of the belt other than the sewn part.

6. The buckle device according to claim 1, wherein a thickness of the sewn part is larger than a thickness of a part of the belt other than the sewn part.

7. The buckle device according to claim 1, wherein a curvature of the sewn part is smaller than a curvature of a part of the belt other than the sewn part, at a winding part of the belt around the winding member.

8. The buckle device according to claim 1, wherein the sewn part is separated from the winding member from a center of the sewn part toward an end part of the sewn part.

9. The buckle device according to claim 1, wherein the sewn part is in a range of a sewn portion at an overlapping part of the belt by a sewn thread.

10. The buckle device according to claim 1, wherein at least one of the one-side covering part or the other-side covering part has flexibility.
